(19) United States
(12) Patent Application Publication
(10) Pub. No.: US 2003/0214147 A1
(43) Pub. Date: Nov. 20, 2003

(54) Dual purpose vehicle shade

(76) Inventor: Debbie Mashburn, Brooklyn, NY (US)

Correspondence Address: Mary A. Whiting, Esq., 214 Slosson Avenue, Staten Island, NY, 10314, US

(21) Appl. No.: 10/446,394

(22) Filed: May 28, 2003

Related U.S. Application Data
(63) Continuation-in-part of application No. 10/029,564, filed on Dec. 28, 2001.
(60) Provisional application No. 60/259,175, filed on Jan. 3, 2001.

(51) Int. Cl. B60J 3/00

(52) U.S. Cl. 296/97.9

(57) ABSTRACT

A shade that is made with a thin piece of resin plastic, which folds at the top. At the fold this shade attaches to the top of the either the driver side or passenger side car door either outside or inside the vehicle, whichever position gives the shade a more airtight fit. The shade can also be attached to the front windshield's sun visor on either the driver side or passenger side. This shade facilitates protection from the sun on the user's face when attached to side window. It also facilitates reduction in sun glare when it is attached to the front windshield's sun visor. It is treated with UV stabilizer which prevents ultraviolet (UV) rays from passing there through.

### CROSS REFERENCE TO RELATED APPLICATIONS

This continuation-in-part application is filed pursuant to 37 CFR 1.53(b). Accordingly, the benefit of earlier filed Ser. No. 10/029,564 is claimed. Ser. No. 10/029,564 is specifically referenced in this continuation-in-part application in submitted application data sheet.

### BENEFIT OF THE PROVISIONAL PATENT APPLICATION No. 60/259,175 FILED Jan. 3, 2001

This invention relates to the structure and function of this invention that allows it to be removable and not permanently attached to the vehicle, in addition providing shade from the sun coming in from the side of the vehicle.

### BACKGROUND—DESCRIPTION OF THE PRIOR ART

Automobiles come equipped with visors to offer some protection from the sun. Such visors are located inside the vehicle and these visors are permanently attached to the vehicle. Unfortunately sunlight often interferes with the driver's comfort level sunlight coming in from the side of the vehicle, which can distract one during driving. In addition, sun glare coming through the front windshield can also be a problem for the inhabitants of the vehicle. Thereafter, inventors created several types of visors in an effort to protect a driver from the sun where the original visor of the car fails.

Prior art devices disclose various devices for automobile shades, whereby the devices are in visor form and or are designed for shading sun from the vehicle driver's and passenger's sight. There are several patents that disclose various visor type inventions.

The present invention differs from these in that it can hang down and attach to both the vehicle's present manufacturer equipped visor to filter sun-glare and UV rays coming through the front windshield as well as attach to the side windows to filter sunlight and UV rays coming through the side windows. The present invention is therefore a dual purpose invention and solves two problems with the same device. Attachment of structures similar to the prior art may damage the original manufacturer equipped visor, or may become bothersome and dangerous to the driver when it is no longer needed or when the driver needs to exit the vehicle expeditiously, as during an emergency or accident. While these previous inventions may be suitable for general use, they would not be suitable for the purpose as disclosed in the present invention. The present invention can be easily and expeditiously installed and removed, needs no additional tools, and will not damage the vehicle's glass, visor or other equipment. Prior are patents concerning shade devices, but not containing the improvements of the present invention are as follows:

| Inventor | U.S. Pat. No. | Date |
|---|---|---|
| Abu-Shumays et. al. | U.S. Pat. No. 4.971,381 | Nov. 20, 1990 |
| Widrig | U.S. Pat. No. D322,056 | Dec. 3, 1991 |
| Robinson | U.S. Pat. No. 5,730,484 | Mar. 24, 1998 |
| Reina, Jr. | U.S. Pat. No. 6,279,984 | Aug. 28, 2001 |

### PRIOR ART REFERENCES

Abu-Shumays et. al., U.S. Pat. No. 4,971,381 dated Nov. 20, 1990 is for a hinge mounted sun visor for automobiles. It is comprised of a visor that are attached to the automobiles by hinge mechanisms, and its position can be adjusted electronically. The present invention differs from Abu-Shumays' invention since it does not need any tools to attach to the vehicle, which facilitates its easy installation and removable in case of an emergency. Abu-Shumays' invention can only be installed on the front windshield visor, while the Applicant's invention can be installed both on the car's visor and the side windows. Thus Applicant's invention has a dual purpose while Abu-Sjumay's invention has only one purpose.

Widrig US D322,056 dated Dec. 3, 1991 is a design patent wherein an ornamental design for a pair of visors with extendable shades for vehicles. This differs from the Applicant's invention since the Applicant's invention serves a useful function; to decrease sun glare and UV rays coming through the vehicle's front windshield and the side windows.

Robinson U.S. Pat. No. 5,730,484, dated Mar. 24, 1998 is for an add-on shading device for the standard automobile visor that must be adjusted up or down by the user. This differs from the Applicant's invention in that the Applicant's invention is of a predetermined range of height, to fit sedan through SUV model cars, and need not be adjusted, which stops any driver distraction during use of the vehicle.

Reina, Jr., U.S. Pat. No. 6,279,984 dated Aug. 28, 2001 is for a visor made of tinted plastic, retracted and stored in the roof of the vehicle. The shield is deployed upon a switch. This differs from the Applicant's invention, in that the Applicant's invention is dual purpose, to assist the driver's side or frontal vision, and is deployed manually.

### OBJECTS AND ADVANTAGES

Accordingly, besides the distinctions from the prior art stated above, several objects and advantages of the present invention are:

To provide for a device wherein the shade is hung from both the original manufacturer equipped visors, and the side windows, thus serving a dual purpose.

To provide for a device wherein once the shade is hung from the original manufacturer equipped visor, there is no adjustment necessary, thus eliminating any chance of creating a bothersome or dangerous situation for the driver.

To provide for a device wherein the user can quickly and easily attach and remove the device.

To provide for a device which can be stored easily, and is not easily damaged under normal wear and tear. To provide for a device that shields the driver and/or the passengers of the vehicle from ultraviolet rays and reduces sun glare.

To provide for a device wherein the range of preferred dimensions are such that the device will fit most make and models of vehicles without any retrofitting by the user.

To provide for a device wherein the shade's structure diminishes the amount of wind that may enter the vehicle and blow against the driver's or passenger's face.

To provide for a device wherein the color of the device is aesthetically pleasing to the user.

To provide for a device wherein no additional tools are required in order to install the device to a vehicle.

To provide for a device wherein the thickness of the device is of sufficient dimension in order for the device to maintain its transparency.

### SUMMARY OF THE INVENTION

In accordance with all the objects and advantages of the invention stated above, a device is disclosed which shade the driver and/or passengers from sun and sun glare as well as filtering ultraviolet light from the driver and/or passengers of the vehicle. This device is especially helpful if the device must be removed expeditiously, such as during an emergency or accident. Various aesthetic features are designed into the device such as differing tones and shades of the device's translucent material's color in order to be aesthetically pleasing to the user while simultaneously functioning as a shade.

The device's form is preferably thick enough to withstand normal wear and tear but thin enough to maintain it's translucent nature. Also, the shade can either be attached with its flat planar surface facing the inside or outside of the vehicle's side window; whichever position gives the most air-tight fit, in order to eliminate any wind from entering the vehicle, hitting against the driver's face, and disturbing the driver.

### BRIEF DESCRIPTION OF THE DRAWINGS

FIG. 1 Illustrates a perspective view of the invention;

FIG. 2 Illustrates a perspective view of the invention, attached to the vehicle's driver side window, with the outer facing portion of the device's planar surface hung on the outside of the vehicle;

FIG. 3 Illustrates a perspective view of the invention, attached to the vehicle's driver side window, with the outer facing portion of the device's planar surface (shown in phantom) hung on the inside of the vehicle;

FIG. 4 Illustrates a cross-sectional view of the device attached to the vehicle's side window, hung as illustrated in FIG. 2;

FIG. 5 Illustrates a perspective view of the invention, attached to the front windshield's visor;

FIG. 6 Illustrates a cross-sectional view of the invention hung as illustrated in FIG. 5;

FIG. 7 Illustrates a cross-sectional view of the device attached to the vehicle's side window, hung as illustrated in FIG. 3.

REFERENCE NUMBERS IN THE DRAWINGS

| | |
|---|---|
| 1. | Device |
| 2. | Concave shaped top portion |
| 3. | Vehicle's roof's window frame |
| 4. | Thickness of device |
| 5. | Vehicle |
| 6. | Side window |
| 7. | Outside surface of side window |
| 8. | Outer facing flat portion |
| 9. | Inner surface of the concave shaped top portion |
| 10a-a′ | Linear line along concave shaped top portion |
| 11. | |
| 12. | Inner facing flat portion |
| 13. | |
| 14. | Distance between the edge of concave shaped top portion and |
| | vehicle's roof's window frame |
| 15. | |
| 16. | Inside surface of side window |
| 17. | Vehicle's front windshield visor |
| 18. | Edge of roof's window frame |
| 19. | Distance between the windshield visor's outer facing planar surface |
| | and the inner facing flat portion of the device |
| 20. | Outer facing planar surface of windshield visor |
| 21. | Handle portion of the windshield visor |
| 22. | Distance between the inner concave shaped surface of the concave |
| | shaped top portion and the handle portion |
| 23. | Edge of concave shaped top portion drawn along line 10a-a′ |
| 24. | Top edge of side window |

### DETAILED DESCRIPTION OF THE PREFERRED EMBODIMENT

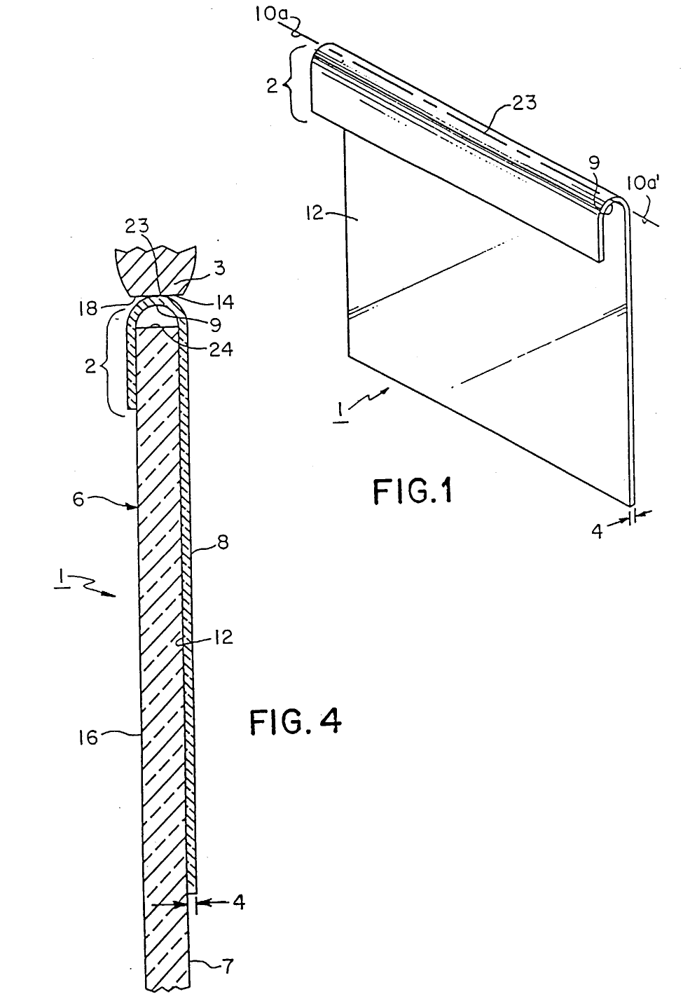

The present invention will now be described in detail utilizing FIGS. 1-7. Referring to the drawings by numerals of reference, this invention relates generally to a shade device for aiding in improving a driver's sight while driving while simultaneously shielding both driver and passenger(s) from ultraviolet rays and sun glare.

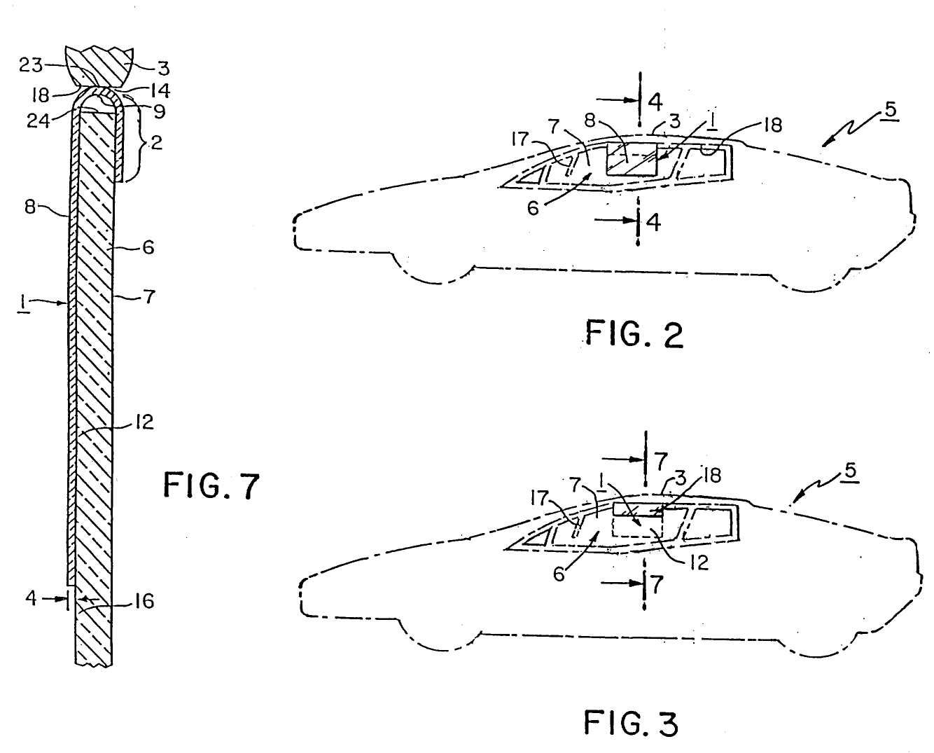

For example, as shown in FIGS. 1 and 2, the rectangular shaped device 1, along it's concave shaped top portion 2, is hung on the top edge 24 of side window 6, aligned parallel to the outside surface 7 of the side window 6 of the vehicle 5. The inner facing flat portion 12 of the device 1 is aligned parallel to the outside surface 7 of the side window 6. The outer facing flat portion 8 of the device 1 is open to the air and does not lay against any surface of the side widow 6.

As shown in FIGS. 1 and 4, when the side window 6 is closed, the measurement of the distance 14 (which is the distance between the edge 23 of the concave shaped top portion 2 along line 10a-a′ (as shown in FIG. 1), and the edge 18 of the vehicle's roof's window frame 3 (shown in partial) in so small or of no value as to not allow any air into the vehicle 5, this eliminating any draft on the driver's or passenger's face during movement of the vehicle 5.

As shown in cross section in FIG. 4, the device 1 is hung on the top edge 24 of the side window 6 with the outer facing flat portion 8 facing the open air. The thickness 4 of the device 1 is sufficiently thin so as not to interfere or impede the air-tight fit when the window 6 is closed.

Also shown in FIGS. 3 and 7, the device 1 can also be hung on the top edge 24 of the side window 6 with the outer facing flat portion 8 facing the inside the vehicle 5, whereby the inner facing flat portion 12 of the device 1 (shown in phantom on FIG. 3), is aligned parallel to the inside surface 16 of the side window 6.

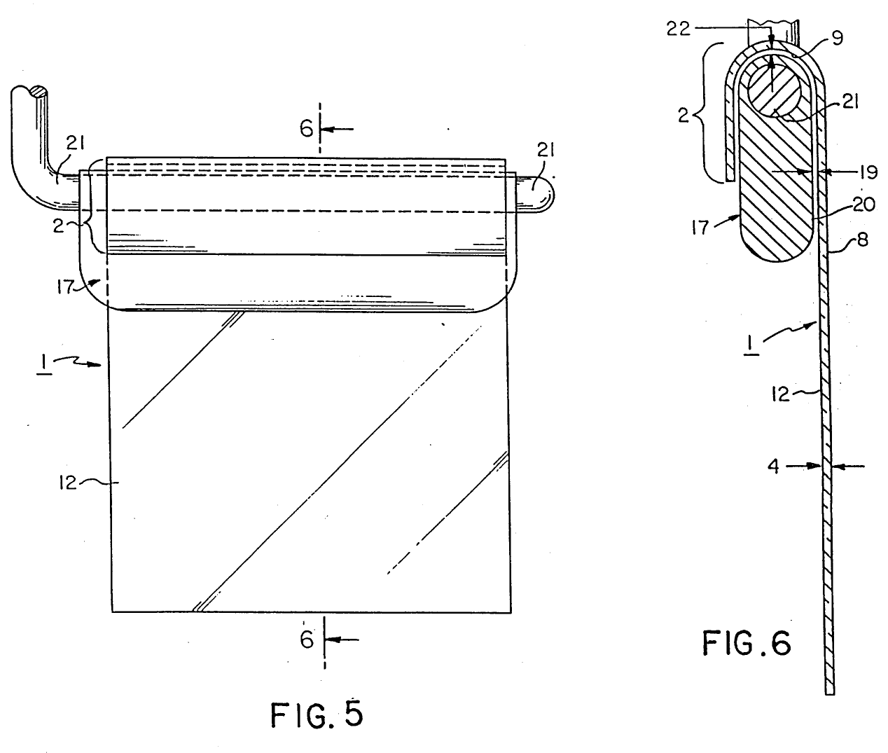

As shown in FIG. 5, the device 1 (partially shown in phantom) can also be removeably attached to the front windshield visor 17, in order to cut down on sun glare for the driver, shield the occupants of the vehicle from UV rays, and provide shade. As further shown in FIG. 6, (drawn along vertical section 6-6 from FIG. 5), when so attached the measurement of the distance 19 (distance between the device's inner facing flat portion 12 and the windshield visor's 17 outer facing planar surface 20 is so small or of no value as to not allow any slippage of the device 1 during movement of the vehicle 5 thus eliminating any adjustment by the driver during driving which may cause distraction and create a dangerous situation. In addition, the inner surface 9 of the concave shaped top portion 2 of the device 1 also fits snugly against the handle portion 21 of the windshield visor 17, the distance 22 (distance between the inner surface 9 of the concave shaped top portion 2, and the handle portion 21), is so small or of no value as to also not allow any such slippage.

The color of the material comprising the device 1 is of a range from light to dark gray in order to be aesthetically pleasing to the driver user, as well as to filter the ultraviolet rays from the driver user and the passenger(s) (i.e., is UV stabilized). Alternate embodiments of the invention can be colored green, blue or amber.

As shown in FIGS. 4, 6 and 7, (cross-sectional views drawn along lines 4-4 in FIG. 2, line 6-6 in FIG. 5, and line 7-7 in FIG. 3, respectively) the thickness 4 of the device 1 is of a sufficient thickness in order to withstand normal wear and tear and as not to diminish the translucent quality of the device 1. The length and width of the device must be long and wide enough in order sufficiently cover the side window 6 and to effectively act as an extension of the windshield visor 17 in order to cut down on sun glare. The length 15 of the concave shaped top portion 23 (shown in FIGS. 4, 6 and 7) must be long enough to sufficiently fit over the side window's top edge 24 and the visor handle 21 to ensure no slippage during use.

The device 1 is preferably comprised of a resin plastic material. However, any conventional materials that retains sufficient translucency and material strength can be substituted in alternate embodiments of the invention.

Those skilled in the art will understand that this description of the present invention provides the basis for numerous alternatives and modifications thereto. These other modifications are also within the scope of the present invention. Accordingly, the present invention is not limited to that as precisely shown and described in this application.

1. A device for use on a vehicle, to provide for shade, diminish sun glare and protect the occupants of said vehicle from ultraviolet rays of the sun, to be hung on the side window of said vehicle, comprising:
a thin translucent rectangular shaped planar structure, further comprising a concave shaped top portion, and an outer facing flat portion, and an inner facing flat portion, and
said concave shaped top portion further comprising an concave shaped inner surface and an outer linear edge,
whereby when said device is removeably hung on the top edge of said side window, said concave shaped top portion slidably fits over said top edge of said side window and said concave shaped inner surface rests on said top edge of said side window, and said outer facing flat portion is exposed to the outside air, and said inner facing flat portion abuts against the outside surface of said side window;
wherein when said side window is closed, said outer linear edge of said concave shaped top portion tightly abuts against the linear edge of the roof window frame of said side window in order to create an air tight seal to stop air drafts from passing through to said occupants of said vehicle.

2. A device as described in claim 1, whereby said device consists of a translucent plastic material of a sufficiently darkened hue in order to provide sufficient shade to said occupants.

3. A device as described in claim 1, whereby said device consists of a translucent plastic material of a sufficient strength in order to withstand normal wear and tear.

4. A device as described in claim 1, whereby the preferred range of said device's width, height and thickness are of a sufficient dimensions in order to provide adequate shade, UV protection and diminished sun glare as well as fitting most makes and models of vehicles.

5. A device for use on a vehicle, to provide for shade, diminish sun glare and protect the occupants of said vehicle from ultraviolet rays of the sun, to be hung on the windshield visor of said vehicle, comprising:
a thin translucent rectangular shaped planar structure, further comprising a concave shaped top portion, and an outer facing flat portion, and an inner facing flat portion, and
said concave shaped top portion further comprising an concave shaped inner surface and an outer linear edge,
whereby when said device is removeably hung on the handle portion of said windshield visor, said concave shaped top portion slidably fits over said handle portion of said side windshield visor and said concave shaped inner surface rests on said handle portion of said windshield visor, and said outer facing flat portion is exposed to the outside air, and said inner facing flat portion abuts against the outside surface of said windshield visor;
wherein when said windshield visor is pulled down, said occupant of said vehicle can look through the said thin translucent rectangular shaped planar structure in order to act as a shield from sun glare and when said windshield visor is pulled up, said device is simultaneously pulled up with said windshield visor and out of the way of said occupant's vision.

6. A device as described in claim 5, whereby said device consists of a translucent plastic material of a sufficiently darkened hue in order to provide sufficient shade to said occupants.

7. A device as described in claim 5, whereby said device consists of a translucent plastic material of a sufficient strength in order to withstand normal wear and tear.

8. A device as described in claim 5, whereby the preferred range of said device's width, height and thickness are of a sufficient dimensions in order to provide adequate shade, UV protection and diminished sun glare as well as fitting most makes and models of vehicles.
